(19) United States
(12) Patent Application Publication
(10) Pub. No.: US 2014/0113997 A1
(43) Pub. Date: Apr. 24, 2014

(54) POLYMERIC MATERIALS

(71) Applicants: Phillip Winrow, Ormskirk West Lancashire (GB); Patrick Brown, Widnes Cheshire (GB); Brian Stewart Jones, Newton-le-Willows Merseyside (GB); Mark Frost, Buxton Derbyshire (GB); Christine Leeming, Manchester (GB)

(72) Inventors: Phillip Winrow, Ormskirk West Lancashire (GB); Patrick Brown, Widnes Cheshire (GB); Brian Stewart Jones, Newton-le-Willows Merseyside (GB); Mark Frost, Buxton Derbyshire (GB); Christine Leeming, Manchester (GB)

(73) Assignee: Colormatrix Holding, Inc., Wilmington, DE (US)

(21) Appl. No.: 14/126,210

(22) PCT Filed: Jun. 18, 2012
(86) PCT No.: PCT/GB2012/051393

§ 371 Date: Dec. 13, 2013

Related U.S. Application Data
(60) Provisional application No. 61/498,074, filed on Jun. 17, 2011.

(51) Int. Cl. C08J 3/20; B29C 47/06; C08K 5/1515; C08K 5/3475; C08K 5/12

(52) U.S. Cl. CPC C08J 3/201; C08K 5/3475; C08K 5/12; C08K 5/1515; B29C 47/065
USPC 524/91; 252/407; 425/505

(57) ABSTRACT

A method of making a sheet structure comprising a first polycarbonate layer which comprises a UV-absorbing compound and a second polycarbonate layer comprises: (i) selecting a liquid formulation comprising a vehicle, for example a trimellitate or low molecular weight acrylic and an UV absorbing additive; and (ii) mixing the liquid formulation with polycarbonate when said first polymeric material is in a molten state, for example in an extruder.

This invention relates to polymeric materials and particularly, although not exclusively, relates to the incorporation of ultraviolet (UV)-absorbing additives into polymeric materials, for example polycarbonates.

It is well-known to introduce UV-absorbing additives into sheets comprising polymeric materials for example polycarbonate for use in construction and/or glazing. The UV-absorbing additives may be incorporated into a relatively thin (e.g. 40 μm) sacrificial polycarbonate cap layer which overlies a thicker primary layer of polymeric material, for example also of polycarbonate. The additives are arranged to absorb UV radiation and limit the amount of UV radiation passing into and through the primary layer. By limiting the passage of UV radiation, the primary layer may be protected from degradation by the radiation and, furthermore, the level of potentially dangerous UV radiation passing to any persons adjacent the sheet may be reduced.

Polycarbonate sheets comprising a cap layer and a primary layer may be made by co-extrusion. Pellets of a pre-compounded mixture comprising polycarbonate and UV-absorbing additive arranged to define the cap layer are co-extruded with further polycarbonate which defines the primary layer. Disadvantageously, to increase the effective level of UV additive using the pre-compounded mixture, the thickness of the cap layer must be increased or a different pre-compounded mixture purchased (which may not always be readily available). Furthermore, during manufacture of the cap layer, the UV additive spends a relatively long time in the extruder which may lead to some degradation and/or a reduction in activity. Additionally, as described in U.S. Pat. No. 6,960,623 and U.S. Pat. No. 7,652,082 volatile components such as UV absorbers may precipitate on calibrators or rollers in the extrusion of sheets which may result in sheet imperfections.

It is an object of the present invention to address at least some of the above-described problems.

It is an object of preferred embodiments of the present invention to provide an improved process for making layers comprising UV-absorbing additives which is versatile, in readily allowing the concentration level of additive to be adjusted and/or which reduces the likelihood of the additive being degraded due to prolonged time at high processing temperatures.

According to a first aspect of the invention, there is provided a method of making a structure which comprises:
(a) a first layer which comprises a first polymeric material and a UV-absorbing compound; and
(b) a second layer;
   wherein said first layer is made in a process which comprises:
(i) selecting a liquid formulation comprising a vehicle and an additive;
(ii) contacting the liquid formulation with said first polymeric material when said first polymeric material is in a molten state.

In said structure, said first and second layers suitably are superimposed on one another and suitably make face to face contact. Said structure preferably comprises a sheet which includes said first layer and said second layer. In some embodiments, said structure may include a third layer over said second layer. Said third layer may comprise a polymeric material and UV-absorbing compound as described herein for said first layer. Said structure comprising said first and second layers, and optional third layer, may be made by co-extrusion.

In the method, the liquid formulation is preferably dosed into said first polymeric material when said first polymeric material is in a molten state. Said first polymeric material may be melted in an extruder and said liquid formulation may be contacted with the first polymeric material in said extruder or downstream thereof. Said liquid formulation is preferably injected at relatively high pressure (e.g. 5-120 bar) into the first polymeric material. A mixing means is suitably provided for facilitating mixing of the liquid formulation and first polymeric material. The mixing means may be provided by using either static or dynamic mixers. Dynamic mixers are preferred in applications where liquid formulations are added to the melt phase of the first polymer i.e. where small amounts of relatively low viscosity fluid (e.g. the liquid formulation) require mixing with large volumes of high viscosity fluid (e.g. molten first polymeric material). The viscosity of the liquid formulation may vary within a wide range, with the proviso that it is fluid and can be pumped for mixing with the first polymeric material. Cavity transfer mixers are especially preferred for mixing the liquid formulation and said first polymeric material due to the high distributive mixing forces that are applied down the length of the mixer enabling the required high shear process to be applied in a controllable manner. Downstream of the point of contact of liquid formulation and first polymeric material, there may be a die for forming the first polymeric material into sheet form.

Suitably, the liquid formulation may be contacted with the first polymeric material so as to minimise the time the liquid formulation is at an elevated temperature. This may obviate some problems associated with prior art methods as described in the introduction of this specification. The residence time of the liquid formulation in the extruder in which the first polymeric material is extruded may be less than 3 minutes, preferably less than 2 minutes, more preferably less than 2 minutes, more preferably less than 1 minute. The residence time may be greater than 10 or 20 seconds. It is suitably about 30 seconds.

Said liquid formulation preferably comprises a vehicle which does not significantly affect the melt-viscosity of said first polymeric material after it has been dosed into the first polymeric material in the method.

Said vehicle is suitably a liquid at STP. Said liquid formulation is preferably a liquid at STP. Said vehicle preferably has a boiling point (at atmospheric pressure) of greater than 200° C., preferably greater than 250° C. The boiling point may be less than 500° C. or less than 400° C. The melting point of the vehicle may be less than 0° C. or less than −10° C.

Preferably, the vehicle has good compatibility with said first polymeric material. Compatibility of the vehicle with polymeric materials may be assessed by examining the level of haze that is created when mouldings are formed. The level of haze may be assessed as described in ASTM D1003-95. The vehicle may be such that when measured as described (at 1 wt %), the haze level is less than 50%, is suitably less than 30%, is preferably less than 20%, is more preferably less than 10% and, especially, is less than 5%.

Preferred vehicles tend not to migrate excessively from layers comprising first polymeric materials once cooled to room temperature.

Preferred vehicles give a low or minimum clouding, for example less than 50% haze (ASTM D1003-95) at levels of up to 5 wt % in the first polymeric material.

The haze of said first layer made in the method (measured according to ASTM D1003-95) may be less than 50%, suitably less than 30%, preferably less than 20%, more preferably less than 10%, especially less than 5%.

Said vehicle may be selected from the following:
Group (A)—low molecular weight acrylics;
Group (B)—tetra, tri- or di-carboxylic acids covalently linked by ester bonds to two or more chains;
Group (C)—adipic acid polymers;
   derivatives (e.g. carboxylic acid derivatives) of adipic acid polymers, for example adipate ester polymers;
   citrates, for example alkyl citrates, such as tributyl citrates;
   phosphate esters, for example tris(2-ethylhexyl) phosphate and 2-ethylhexyldiphenyl phosphate;
   phthalates, for example C₄ to C₁₃ phthalates such as di(2-ethylhexyl)phthalate or di-octylphthalate;
   sebacates;
   azelates;
   chlorinated paraffins with between 20-70% chlorination level;
   epoxidized oils (e.g. naturally-occurring oils), for example epoxidized soy bean oil or epoxidized linseed oil;
   acetylated hydrogenated castor oils.

The weight average molecular weight (Mw) of said Group (A) vehicle may be less than 5000, suitably less than 4000, preferably less than 3000, more preferably less than 2000. Mw may be at least 500, preferably at least 1000, more preferably at least 1500. Preferably, the Mw is in the range 1500-3000, more preferably 1500-2000.

The polydispersity (weight average molecular weight divided by number average molecular weight—i.e. Mw/Mn of said Group (A) vehicle may be in the range 1 to 3, preferably 1.2 to 2.5, more preferably 1.2 to 2. In a preferred embodiment, it is in the range 1.55 to 1.75.

The viscosity of said Group (A) vehicle (at 25° C.) may be in the range 100 to 2000 cP, preferably 280 to 1000 cP, more preferably 300 to 800 cP.

The glass transition temperature (Tg) of said Group (A) vehicle may be in the range −100° C. to −30° C.

Group (A) vehicles may be multi-functional styrene-acrylic oligomers. They may have low molecular weight (e.g. CMn <3000). They may have general formula

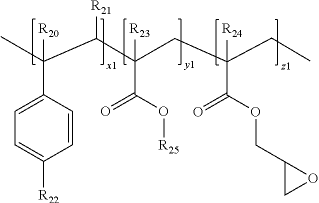

where R₂₀ to R₂₄ are independently selected from a hydrogen atom, or an alkyl or a higher (e.g. C₂-C₂₀) alkyl group, R₂₅ is an alkyl group and x1, y1 and z1 are independently in the range 1 to 20.

Group (A) vehicles may comprise optionally-substituted, preferably unsubstituted, alkylacrylate moieties, for example repeat units. The optionally-substituted, preferably unsubstituted, alkylacrylate may comprise a C₂₋₁₀ alkylacrylate, preferably a C₂₋₆alkylacrylate and, especially, comprises a butylacrylate. Thus, preferred Group (A) vehicles comprise polyalkylacrylate, for example poly C₂₋₆ alkylacrylate, and especially comprise polybutylacrylate polymers.

Group (B) vehicles may comprise aromatic or aliphatic tetra, tri- or di-carboxylic acids covalently linked by ester bonds to two or more chains.

In group (B) vehicles, the chains could be optionally-substituted, preferably unsubstituted, linear or branched, alkyl groups. The chains could comprise linear or branched alkyl groups with between 5 and 15 carbon atoms, more preferably 7 and 10 carbon atoms which are preferably unsubstituted. An example of a preferred branched alkyl chain is 2-ethylhexyl.

The chains could also comprise polyalkoxylated fatty alcohol chains. The preferred fatty alkoxylated esters are polyalkoxylated fatty alcohol chains:

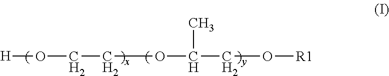

The chains suitably form ester bonds via the —O— moiety at the left hand side of structure I.

The chains could also comprise citric acid esters:

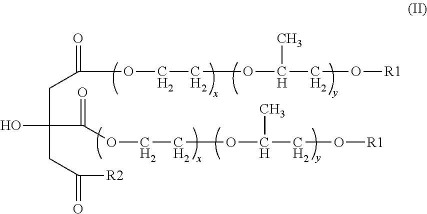

where R² is either —OH or a polyalkoxylated fatty alcohol chain of the same or similar structure to (I). Said citric acid esters may form ester bonds with the carboxylic acid via the —OH group shown at the left of structure II.

R1 may be unsaturated or saturated, unsubstituted or substituted, aromatic or aliphatic fatty moiety with between 1 and 20 (for example between 1 and 10) carbon atoms. x and y may independently be between 0 and 10. The sum of all x and y must be greater than 0. The sum of all x and y preferably does not exceed 70.

The aliphatic dicarboxylic acid species may contain between 2 and 22 carbon atoms in the main structural backbone, more preferably between 2 and 10 with a typical structure being outlined below:

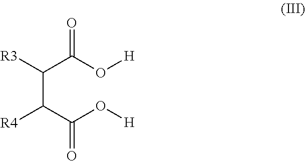

where R³ and R⁴ independently represent optionally-substituted alkyl, alkenyl or alkynyl groups or R³ and R⁴ together with the atoms to which they are bonded define an optionally-substituted cyclic moiety. R³ and R⁴ suitable independently include 0-20, preferably 2-10, more preferably 2-4 carbon atoms. Examples of dicarboxylic acids include succinic acid, malonic acid and maleic acid.

Preferably, R³ and R⁴ together with the atoms to which they are bonded define an optionally-substituted cyclic, preferably aromatic moiety. Preferably, said aromatic moiety has six ring atoms, preferably six ring carbons atoms. Optional substituents of the cyclic, for example aromatic, moiety, may be independently selected from ester and optionally-substituted, preferably unsubstituted, alkyl groups. When said cyclic moiety is substituted, it is preferably substituted at two or fewer or one or fewer positions. Thus, preferably, at least two substituents on the cyclic structure represent hydrogen atoms and preferably three or all four of the substituents on the cyclic structure represent hydrogen atoms.

Preferred aromatic carboxylic acids may contain between 6 and 20, more preferably 8 and 12 carbon atoms. Preferably, said carboxylic acid is of general formula:

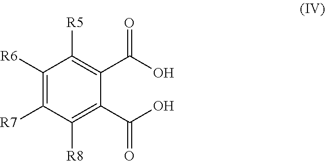

wherein R⁵, R⁶, R⁷ and R⁸ independently represent a hydrogen atom, an ester group or an optionally-substituted, preferably unsubstituted, alkyl group. An example of a suitable aromatic dicarboxylic acid is phthalic acid. 1,2 phthalic acid is preferred to give appropriate ortho functionality.

A preferred Group (B) vehicle is a tri-carboxylic acid of general formula:

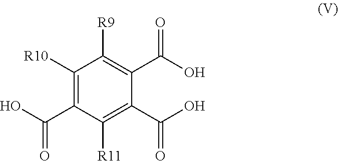

where R⁹, R¹⁰ and R¹¹ independently represent a hydrogen atom, an ester group or an optionally-substituted, preferably unsubstituted, alkyl group.

Unless otherwise stated, optional substituents described herein include halogen atoms and alkyl, acyl, nitro, cyano, alkoxy, hydroxy, amino, alkylamino, sulphinyl, alkylsulphinyl, sulphonyl, alkylsulphonyl, sulphonate, amido, alkylamido, alkoxycarbonyl, halocarbonyl and haloalkyl groups.

Unless otherwise stated, alkyl, alkenyl or alkynyl groups may have up to twenty carbon atoms, preferably up to fifteen carbon atoms, more preferably up to eleven carbon atoms.

The preferred ester-containing vehicles in Group (B) are formed by reacting the described carboxylic acids (for example di or tri-carboxylic acids) with alkyl-containing moieties to provide the alkyl groups; or may be reacted with polyalkoxylated fatty alcohols or citric acid esters. The alkoxylating moieties are preferably present at between 1 and 80 moles per each fatty alcohol, more preferably between 1 and 70 and most preferably between 1 and 60 moles per fatty alcohol.

The fatty alcohols such as species (I) or (II) may be prepared by the polyalkoxylation of saturated or unsaturated, substituted or unsubstituted aliphatic or aromatic fatty alcohols. As is well known to those skilled in the art, the fatty moieties are often present as a mixture and so the vehicle may comprise a mixture of compounds.

The dicarboxylic acid based esters are suitably esterified on both the carboxylic acid moieties. The tricarboxylic acid derived compounds are suitably esterified on two or three of the carboxylic acid groups with the above described alkyl or polyalkoxylated fatty alcohol.

The fatty alkoxylate esters may be prepared by reaction of the starting alcohol with either ethylene or propylene oxide in the presence of an acidic or basic catalyst.

X represents the number of ethylene oxide which are incorporated into each fatty alcohol chain and y represents the number of moles of propylene oxide that are incorporated into the chain. The chain may consist of both block co-polymers or a mixture of the polymer types. Preferably, said Group (B) vehicle has a boiling point of greater than 285° C.

Preferably, said Group (B) vehicle has a molecular weight in the range 500 to 4200 g/mol.

Preferably, said Group (B) vehicle has a viscosity of between 100,000 cP and 1,000 cP, more preferably between 50,000 cP and 2,000 cP and most preferably between 5,000 and 30,000 cP as measured using a Brookfield viscometer using spindle number 7 at 21° C. at a torque value of ˜50%. The formulation is suitably both pumpable and stable to sedimentation of any solid particulates that may be present.

In Group (C) preferred vehicles are selected from adipic acid polymers and their derivatives, phosphate esters, phthalate esters and phthalate ester-type structures and epoxidised oils.

Especially preferred Group (C) vehicles are adipic acid polymers or derivatives of adipic acid polymers, with adipate ester polymers being especially preferred.

Said vehicle is preferably selected from Group (B).

Said additive in said liquid formulation is suitably a UV-absorbing additive which is arranged to absorb UV radiation incident on a first layer of the structure. Said UV-absorbing additive is suitably capable of actively protecting polycarbonate (or other polymers) from UV light due to their absorptive capacity at wavelengths below 400 nm, and suitably which have a molecular weight of more than 370 g/mol, preferably 500 g/mol or more. Suitable additives are described at column 6 line 48 to column 7 line 42 of U.S. Pat. No. 6,359,042B, the content of which is incorporated herein by this reference. Preferred UV-absorbing additives may be selected from 2-(2′-Hydroxyphenyl)benzotriazoles, for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-[alpha],[alpha]-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyl-oxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂—]—₂ where R=3′-tert-butyl-4′-hydroxy-5′-2H-benzotriazol-2-ylphenyl, 2-[2′-hydroxy-3′-[alpha],[alpha]-dimethylbenzyl)-5′-(1,1,3,3-tetramethylbutyl)-phenyl]-benzotriazole; 2-[2′-hydroxy-3′-(1,1,3,3-tetramethylbutyl)-5′-[alpha],[alpha]-dimethylbenzyl)-phenyl]benzotriazole. Other preferred UV-absorbing additives include: Tinuvin 1600 Chemical Name: 3-(diaryl)[1,3,5]triazin-2-yl)-5-(alkoxy substituted)-phenol Supplier: BASF; and Tinuvin 1577 2 Chemical Name: 2-(4,6-diphenyl-1,3,5-triazin-2-yl)-5-[(hexyl)oxy]-phenol CAS: 174315-50-2.

Said formulation may include at least 20 wt %, suitably at least 25 wt %, preferably at least 30 wt %, more preferably at least 35 wt % of vehicle, wherein the reference to “vehicle” refers to the total of all vehicles present in the formulation. Said liquid formulation may include less than 80 wt %, less than 70 wt %, less than 60 wt %, less than 50 wt % or less than 45 wt % vehicle. Typically the formulation includes 20 to 60 wt % vehicle, preferably 25 to 55 wt %, more preferably 35 to 45 wt % vehicle.

Said liquid formulation may include at least 20 wt %, suitably at least 30 wt %, preferably at least 40 wt %, more preferably at least 50 wt %, especially at least 55 wt % of UV-absorbing additive. The aforementioned levels of UV-absorbing additive may refer to the level of one UV absorbing additive but suitably refer to the total of all UV absorbing additives in the formulation. Said liquid formulation may include less than 65 wt %, less than 60 wt % or less than 50 wt % of UV-absorbing additives.

Typically the formulation includes 40 to 80 wt % vehicle and 20 to 60 wt % UV-absorbing additives; preferably includes 45 to 75 wt % vehicle and 25 to 55 wt % of UV-absorbing additives.

Said liquid formulation suitably comprises a dispersion of UV additive in said vehicle.

Said liquid formulation may include other components, for example at 5 wt % or less. For example, said liquid formulation may include a toner, for example less than 0.1 wt % of toner. Said formulation may include one or more infrared absorbers, for example TiN. Said formulations may include one or more antioxidant, for example Irganox 1076. Said liquid formulation may include one or more stabilisers for stabilising the liquid formulation, for example the dispersion of UV additive in the vehicle. An example is a silica.

Said liquid formulation may have a viscosity of less than 50000 cp at 25° C. measured using a standard Brookfield viscometer, for example at 20 rpm and spindle 7. Preferably, the viscosity as aforesaid is in the range 10000 to 25000 cp.

Said first polymeric material may be a transparent and translucent polymeric material. Said first polymeric materials may be selected from polycarbonate, polyesters, acrylics, halogenated polymers such as polyvinylchloride (PVC), polyolefins, aromatic homopolymers and copolymers derived from vinyl aromatic monomers and graft copolymers thereof such as acrylnitril-butadiene-styrene terpolymer (ABS), containing these polymers as major component or in essentially pure form (e.g. 50-100 wt %).

Preferably, said first polymeric material is selected from polycarbonate, polymethylmethacrylate, (PMMA), polyethyleneterephthalate (PET, PET-G), PVC, transparent ABS, polyvinylidene fluoride (PVDF), styrene-acrylnitril copolymer (SAN), polypropylene (PP), polyethylene (PE) including blends, alloys, co-polymers.

In an especially preferred embodiment, said first polymeric material comprises (or more preferably consists essentially of) polycarbonate.

Preparation of polycarbonates to be used as described herein may be performed in a known manner from diphenols, carbonic acid derivatives, optional chain terminators and optional branching agents, wherein some of the carbonic acid derivatives are replaced by aromatic, dicarboxylic acids or derivatives of dicarboxylic acids in order to prepare polyester carbonates. Polycarbonate as described herein is suitable a thermoplastic and includes aromatic polyester carbonates. Polycarbonates may have average molecular weights Mw (determined by measuring the relative viscosity at 25° C. in CH₂Cl₂ at a concentration of 0.5 g/100 ml CH₂Cl₂) of 27,000 to 40,000, preferably 30,000 to 36,000 and in particular 32,000 to 36,000. Diphenols which are suitable for preparing the polycarbonates include, for example, hydroquinone, resorcinol, dihydroxydiphenyl, bis-(hydroxyphenyl) alkanes, bis-(hydroxyphenyl)-cycloalkanes, bis-(hydroxyphenyl) sulfides, bis-(hydroxyphenyl)-ethers, bis-(hydroxyphenyl)-ketones, bis-(hydroxyphenyl) sulfones, bis-(hydroxyphenyl) sulfoxides, [alpha],[alpha]′-bis-(hydroxyphenyl)-diisopropylbenzenes and their ring-alkylated and ring-halogenated derivatives. Preferred diphenols are 4,4′-dihydroxydiphenyl, 2,2-bis-(4-hydroxyphenyl)-propane, 2,4-bis-(4-hydroxyphenyl)-2-methylbutane, 1,1-bis-(4-hydroxyphenyl)-p-diisopropylbenzene, 2,2-bis-(3-methyl-4-hydroxyphenyl)-propane, 2,2-bis(3-chloro-4-hydroxyphenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl) sulfone, 2,4-bis-(3,5-dimethyl-4-hydroxyphenyl)-2-methylbutane, 1,1-bis-(3,5-dimethyl-4-hydroxyphenyl)-p-diisopropyl benzene, 2,2-bis-(3,5-dichloro-4-hydroxyphenyl)-propane, 2,2-bis-(3,5-dibromo-4-hydroxyphenyl)-propane and 1,1-bis-(4-hydroxyphenyl)-3,3,5-trimethylcyclohexane. Particularly preferred diphenols are 2,2-bis-(4-hydroxyphenyl)-propane, 2,2-bis-(3,5-dimethyl-4-hydroxyphenyl)-propane, 2,2-bis-(3,5-dichloro-4-hydroxyphenyl)-propane, 2,2-bis-(3,5-dibromo-4-hydroxyphenyl)-propane, 1,1-bis-(4-hydroxyphenyl)-cyclohexane and 1,1-bis-(4-hydroxyphenyl)-3,3,5-trimethylcyclohexane. These and other suitable diphenols are described, for instance, in U.S. Pat. Nos. 3,028,635, 2,999,835, 3,148,172, 2,991,273, 3,271,367, 4,982,014 and 2,999,846, in German patents 1 570 703, 2 063 050, 2 036 052, 2 211 956 and 3 832 396, in French patent 1 561 518, in the monograph “H. Schnell, Chemistry and Physics of Polycarbonates, Interscience Publishers, New York 1964” and in Japanese patents 62039/1986, 62040/1986 and 105550/1986. In the case of homopolycarbonates only one diphenol is used, in the case of copolycarbonates several diphenols are used. Other detail on preparation of polycarbonates is detailed in U.S. Pat. No. 6,359,042.

Said first layer may have a thickness of less than 500 μm, suitably less than 250 μm, preferably less than 100 μm, more preferably less than 75 μm, especially less than 50 μm. Said first layer may have a thickness in the range 5 μm to 100 μm, preferably 20 μm to 50 μm.

Said second layer may comprise a second polymeric material. Said second polymeric material may be a transparent and translucent polymeric material. Said second polymeric material may be selected from polycarbonate, polyesters, acrylics, halogenated polymers such as polyvinylchloride (PVC), polyolefins, aromatic homopolymers and copolymers derived from vinyl aromatic monomers and graft copolymers thereof such as acrylnitril-butadiene-styrene terpolymer (ABS), containing these polymers as major component or in essentially pure form (e.g. 50-100 wt %).

Preferably, said second polymeric material is selected from polycarbonate, polymethylmethacrylate, (PMMA), polyethyleneterephthalate (PET, PET-G), PVC, transparent ABS, polyvinylidene fluoride (PVDF), styrene-acrylnitril copolymer (SAN), polypropylene (PP), polyethylene (PE) including blends, alloys, co-polymers.

In an especially preferred embodiment, said second polymeric material (and more preferably also said first polymeric material) comprises (or more preferably consists essentially of) polycarbonate. Said first and second layers preferable comprise the same polymeric material, especially polycarbonate.

Said first layer suitably includes 0.1 to 20 wt %, preferably 2 to 15 wt %, more preferably 5 to 10 wt % of said UV-absorbing additives.

Said second layer suitably includes 0 to 1 wt %, preferably 0 to 0.5 wt % of said UV-absorbing additives. Preferably, said second layer includes substantially no UV-absorbing additives. It may comprise more than 98 wt %, suitably more than 99 wt % of a first polymeric material as described herein. Said second layer preferably consists essentially of a single type of second polymeric material.

Said second layer suitably has a thickness which is greater than that of said first layer. The ratio of the thickness of the second layer divided by the thickness of the first layer may be at least 10, is suitably at least 25, is preferably at least 50, is more preferably at least 75 and especially is at least 100. Said second layer may have a thickness in the range 1 mm to 15 mm, for example 3 mm to 12 mm or 4 mm to 11 mm.

According to a second aspect of the invention, there is provided a liquid formulation for use in the method of the first aspect, said liquid formulation having any feature of the liquid formulation of the first aspect.

According to a third aspect of the invention, there is provided a structure which comprises:
(a) a first layer which comprises a first polymeric material and a UV-absorbing compound; and
(b) a second layer,
   wherein said first layer includes one or more of the following:
(a) free vehicle of the type described according to the first aspect;
(b) a residue derived from vehicle of the type described according to the first aspect.

Free vehicle can be tested for by chromatographic techniques, for example GC-MS.

Said first and second layers are preferably co-extruded. Said first and second layers preferably comprise co-extruded polycarbonate sheets. Suitably, the first layer is an outside or external layer of the structure.

According to a fourth aspect, there is provided an assembly comprising:

(a) a first extruder for extruding first polymeric material;
(b) a receptacle containing a liquid formulation as described according to the first aspect;
(c) injection means operatively connected to the receptacle for injecting liquid formulation extracted from the receptacle into the polymeric material in or downstream of the first extruder;
(d) mixing means for mixing liquid formulation and first polymeric material.

Said assembly preferably includes a mixing means as described according to the first aspect.

The assembly preferably comprises a second extruder which is arranged to cooperate with the first extruder for forming a co-extruded sheet using the first and second extruders.

The injection means is preferably arranged to inject liquid formulation at a position towards an outlet of the first extruder, suitably to minimize residence time of the liquid formulation in the extruder. Downstream of the position of injection, there may be arranged a pump means, for example a melt gear pump, arranged to lower the pressure associated with the molten material in the first extruder at the position wherein the liquid formulation is dosed into the molten material.

Any invention described herein may be combined with any feature of any other invention or embodiment described herein mutatis mutandis.

Specific embodiments of the invention will now be described, by way of example, with reference to the accompanying drawings in which:

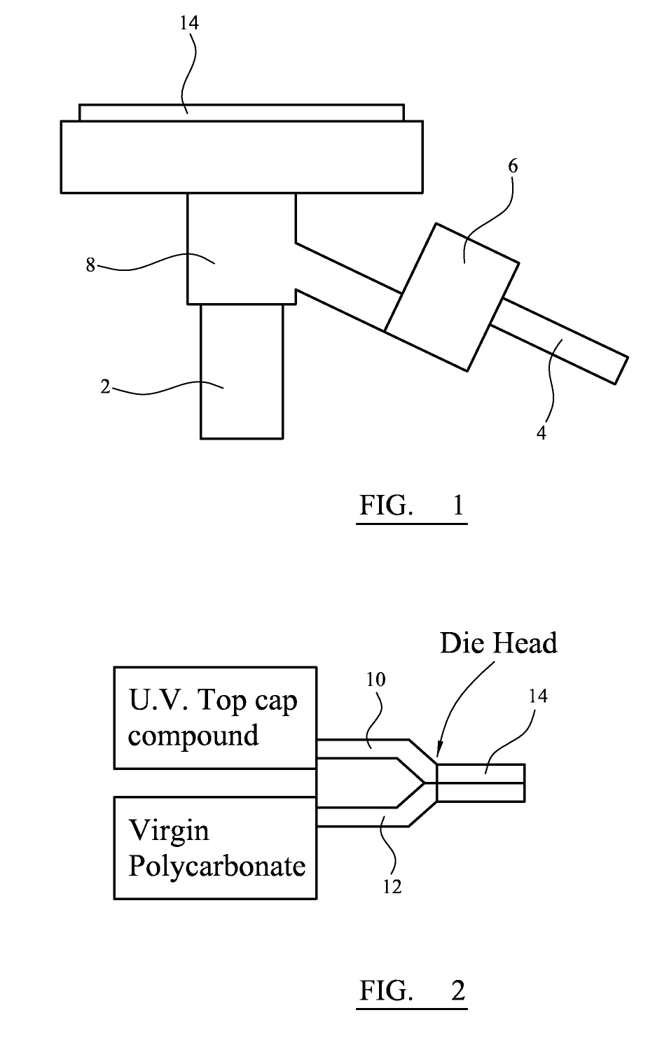

FIG. 1 is a schematic top view of apparatus for producing co-extruded sheet which contains a UV-absorbing additive in a top cap layer;

FIG. 2 is a schematic representation of a die head and layers produced thereby.

The reference “pbw” herein refers to “parts by weight”.

Referring to FIG. 1, there is shown a main extruder 2 and a side extruder 4. A cavity transfer mixer 6 is operatively connected to the side extruder and is arranged to inject a liquid formulation into the molten polymer in extruder 4 just prior to a die head 8 which is arranged to form the molten streams from extruders 2 and 4 into respective layers 10, 12 (FIG. 2) of a sheet materials 14.

In a preferred embodiment, both of the extruders 2, 4 run polycarbonate (suitably exactly the same material). The cavity transfer mixer injects a liquid formulation which includes a liquid vehicle and a UV absorbing compound. Thus, the layer 10 of FIG. 2 includes about 5 wt % of UV absorbing compound. The provision of the UV absorbing compound extends the life of the sheet 14 and prevents or reduces yellowing.

The liquid formulation may be prepared as described in Example 1.

### EXAMPLE 1

### Preparation of Liquid Formulation

A vehicle comprising a C₇-C₉ trimellitate (389.79 pbw) was selected and to this was added with mixing a commercially available benzotriazole UV absorber (600 pbw). Then Cab-O-sil (fumed silica) (10 pbw) was added with mixing followed by Solvent Violet 13 (0.21 pbw), a violet toner. The mixture was mixed thoroughly until all solids were fully dispersed.

Prior to use of the apparatus of FIG. 1, the cavity transfer mixer was assessed to calculate the output of liquid formulation (and particularly the output of UV absorber per revolution); and the throughput of polycarbonate in the extruder per minute was calculated.

With extruders 2, 4 running virgin polycarbonate, the liquid formulation described was dosed by the cavity transfer mixer at the end of extruder 4 at a rate so as to delivery 8.33 wt % of formulation (equivalent to 5 wt % of UV absorber) into the polycarbonate. For example, if the extruder 4 outputs at 10 g/min and a single revolution of the pump doses 0.1 g then 88.3 revolutions per minute are needed to dose to generate a LDR of 8.33%.

By use of the cavity transfer mixer and liquid formulation, it is straight forward to vary the level of UV additive in the cap layer 10. Furthermore, since the UV additive is subjected to the temperature of extruder 4 for a short time, volatilisation of the UV additive and/or thermal degradation will be minimized. Thus, less UV additive may be required than hitherto.

The apparatus and method described allow increased flexibility and quicker change times between grades of sheet with different level of UV protection. In addition, the liquid formulation can include other functional additives (e.g. IR absorbers and reflectors, toners, colourants and other functional materials as may be required for any particular application).

In a variation on the apparatus, a melt gear pump may be provided directly downstream of the mixer 6. This may facilitate production of a constant thickness for layer 10, allow the cavity transfer mixer to dose into a lower pressure zone (e.g. of 100 bar) and reduce the work done by extruder 4.

### EXAMPLES 2 TO 4

### Preparation of Other Liquid Formulations

Examples 2 to 4 are prepared by premixing all the liquid components then the solid components are added gradually under constant stirring. After all the components have been added the mixer speed is increased to produce a smooth vortex and held at this speed for 2 minutes until all the components were fully dispersed. The formulations were allowed to cool to ambient temperature and their viscosities were measured at 20° C. using a Brookfield viscometer (20 rpm, spindle No. 7).

TABLE 1

| Component | Example 2 | Example 3 | Example 4 |
|---|---|---|---|
| Tinuvin 360 (UV absorber) | 60.0 | 60.0 | 57.5 |
| Joncryl ADP 1200 | 0 | 34.579 | 42.079 |
| (liquid acrylic vehicle) | | | |
| Diplast TM8 (vehicle | | | |
| based on trimellitic | 39.579 | 5.0 | 0 |
| anhydride and n-octanol) | | | |
| Cab-o-sil (fumed silicas | 0.4 | 0.4 | 0.4 |
| Solvent Violet 13 (toner) | 0.021 | 0.021 | 0.021 |
| Brookfield Viscosity @ | | | |
| 20° C. (20 rpm, spindle 7) | 12,800 cP | 22,800 cP | 22,200 cP |

### EXAMPLE 5

### Comparative

A pelletized polycarbonate UV additive compound was prepared by compounding 9.5 kg of polycarbonate (Makrolon 3107 which had been pre-dried at 120° C. for 4 hours) with 500 g of Tinuvin 360 on a PRISM TSE 24 mm twin screw extruder (L/D ratio of 40/1) at 300° C.

### EXAMPLE 6

### Comparative

A sample of example 5 was dried at 120° C. for 4 hours and extruded through a 25 mm (L/D ratio of 24/1) Killin single screw to simulate the thermal history experienced when it is co-extruded into a top-cap sheet. The active concentration of Tinuvin 360 in the extruded sheet was determined by HPLC analysis and the melt viscosity of the compound was determined by capillary rheometry and results are provided in table 2.

### EXAMPLES 7 TO 9

### Melt Injection

Using a 25 mm (L/D ratio of 24/1) Killion single screw extruder fitted with a cavity transfer mixer (CTM) between the end of the extruder and before the strand die (4×3 mm holes) the liquid UV formulations (examples 2 to 4) were melt injected through the CTM into polycarbonate at 300° C. to produce examples 7 to 9, respectively. The active concentration of Tinuvin 360 in the extruded sheet was determined by HPLC analysis as described in Example 10, the melt viscosity of the compound was determined by capillary rheometry and results are provided in table 2

### EXAMPLE 10

### HPLC Determination of Tinuvin 360 in Examples 6 to 9

The active % of Tinuvin 360 was determined by HPLC analysis using an Agilant 1100 HPLC fitted with an Eclipse XDB (C18, 3.5 μm, 4.6×100 mm) and a UV-Vis DAD, 1024-element photodiode detector. Samples for analysis were prepared by dissolving 220 mg of polycarbonate sample into 44 g of tetrahydrofuran. After the samples had fully dissolved 37.58 g of acetonitrile was added to precipitate the polycarbonate. After the acetonitrile is added two layers are formed, the top acetonitrile layer contains the precipitated polycarbonate and the bottom tetrahydrofuran layer contains the Tinuvin 360. A 100 μl sample of the tetrahydrofuran layer was then injected onto the HPLC column to determine the concentration of Tinuvin 360 in the solution and thus the concentration in the polycarbonate sample.

### EXAMPLE 11

### Melt Viscosity Measurements of Examples 6 to 9

The melt viscosity (MV) of examples 6 to 9 were measured using a Rosand RH7 capillary viscometer at 295° C. and a shear rate of 400 s⁻¹. The polycarbonate (Makrolon 3107) has an MV of 848 Pa·s under the same conditions. Results are provided in table 2

TABLE 2

| | | Active Tinuvin | Melt viscosity @ |
|---|---|---|---|
| | UV liquid | 360 determined | 295° C. shear rate |
| Example | dispersion | by HPLC | 400 s⁻¹ |
| Comparative | — | 3.96% | 427 Pa · s |
| Example 6 | | | |
| 7 | 8.33% Example 2 | 4.93% | 638 Pa · s |
| 8 | 8.33% Example 3 | 4.91% | 431 Pa · s |
| 9 | 8.67% Example 4 | 4.94% | 425 Pa · s |

The results in table 2 demonstrate that, compared to example 6, melt injection of liquid formulations of Tinvin 360 into a dynamic mixer at the end of the polymer extrusion process as in examples 7 to 9 results in hardly any of the added Tinuvin 360 being lost due to thermal degradation during the melt injection process. The results also show that the melt injection examples have substantially the same or higher melt viscosity compared to comparative example 6 showing the addition of the carrier has not had any detrimental effect on polymer melt viscosity. In addition, it is noted that Example 7 advantageously does not reduce the melt viscosity of the starting polycarbonate as much as Comparative Example 6 or Examples 8 and 9.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of making a structure which comprises:
(a) a first layer which comprises a first polymeric material and a UV-absorbing compound; and
(b) a second layer;
wherein said first layer is made in a process which comprises:
(i) selecting a liquid formulation comprising a vehicle and an additive;
(ii) contacting the liquid formulation with said first polymeric material when said first polymeric material is in a molten state.

2. A method according to claim 1, wherein said structure comprises a sheet which includes said first layer and said second layer.

3. A method according to claim 1, wherein said first polymeric material is melted in an extruder and said liquid formulation is contacted with the first polymeric material in said extruder or downstream thereof.

4. A method according to claim 1, wherein a mixing means is provided for mixing of the liquid formulation and first polymeric material.

5. A method according to claim 4, wherein said mixing means is a cavity transfer mixer.

6. A method according to claim 1, wherein said first polymeric material is extruded to define the first layer and the residence time of the liquid formulation in the extruder in which the first polymeric material is extruded is less than 2 minutes

7. A method according to claim 1, wherein the vehicle is such that when measured according to ASTM D1003-95 at 1 wt %, the haze level is less than 20%.

8. A method according to claim 1, wherein said vehicle is selected from the following:
Group (A)—low molecular weight acrylics;
Group (B)—tetra, tri- or di-carboxylic acids covalently linked by ester bonds to two or more chains;
Group (C)—adipic acid polymers;
derivatives, for example carboxylic acid derivatives of adipic acid polymers, for example adipate ester polymers;
citrates, for example alkyl citrates, such as tributyl citrates;
phosphate esters, for example tris(2-ethylhexyl) phosphate and 2-ethylhexyldiphenyl phosphate;
phthalates, for example C₄ to C₁₃ phthalates such as di(2-ethylhexyl)phthalate or di-octylphthalate;
sebacates;
azelates;
chlorinated paraffins with between 20-70% chlorination level;
epoxidized oils (e.g. naturally-occurring oils), for example epoxidized soy bean oil or epoxidized linseed oil;
acetylated hydrogenated castor oils.

9. A method according to claim 8, wherein Group (A) vehicles are multi-functional styrene-acrylic oligomers.

10. A method according to claim 8, wherein Group (A) vehicles have a general formula 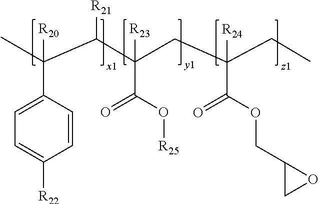
where R₂₀ to R₂₄ are independently selected from a hydrogen atom, or an alkyl or a higher alkyl group, R₂₅ is an alkyl group and x1, y1 and z1 are independently in the range 1 to 20.

11. A method according to claim 8, wherein Group (A) vehicles comprise optionally-substituted alkylacrylate repeat units.

12. A method according to claim 8, wherein Group (B) vehicles comprise optionally-substituted linear or branched, alkyl groups with between 5 and 15 carbon atoms.

13. A method according to claim 8, wherein the tetra, tri- or di-carboxylic acids of Group (B) are derived from aliphatic dicarboxylic acids which contain between 2 and 22 carbon atoms in the main structural backbone; or the tetra, tri- or di-carboxylic acids of Group (B) are derived from aromatic carboxylic acids which contain between 6 and 20 carbon atoms.

14. A method according to claim 8, wherein the tetra, tri- or di-carboxylic acids of Group (B) are derived from a carboxylic acid of formula: 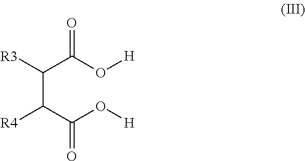
where R³ and R⁴ independently represent optionally-substituted alkyl, alkenyl or alkynyl groups or R³ and R⁴ together with the atoms to which they are bonded define an optionally-substituted cyclic moiety; or derived from a carboxylic acid of formula 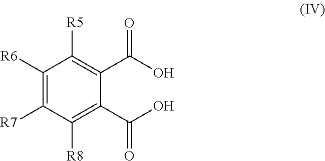
wherein R⁵, R⁶, R⁷ and R⁸ independently represent a hydrogen atom, an ester group or an optionally-substituted alkyl group.

15. A method according to claim 8, wherein said Group (B) vehicle is a tri-carboxylic acid of general formula: 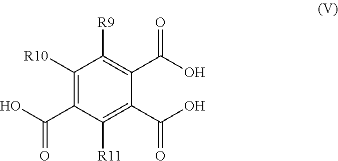
where R⁹, R¹⁹ and R¹¹ independently represent a hydrogen atom, an ester group or an optionally-substituted alkyl group.

16. A method according to claim 8, wherein said vehicle is selected from Group (A) and Group (B) vehicles and optionally comprises a mixture of Group (A) and Group (B) vehicles.

17. A method according to claim 8, wherein said Group (B) vehicle has a boiling point of greater than 285° C.

18. A method according to claim 8, wherein said Group (B) vehicle has a molecular weight in the range 500 to 4200 g/mol.

19. A method according to claim 8, wherein said Group (B) vehicle has a viscosity of between 100,000 cP and 1,000 cP, as measured using a Brookfield viscometer using spindle number 7 at 21° C. at a torque value of ˜50%.

20. A method according to claim 8, wherein said vehicle is selected from Group (B).

21. A method according to claim 1, wherein said additive in said liquid formulation is a UV-absorbing additive which is arranged to absorb UV radiation incident on said first layer of the structure.

22. A method according to claim 21, wherein said UV-absorbing additive is capable of actively protecting polymers from UV light due to its absorptive capacity at wavelengths below 400 nm.

23. A method according to claim 1, wherein said formulation includes at least 20 wt % of vehicle and 80 wt % or less of vehicle.

24. A method according to claim 1, wherein said liquid formulation includes at least 20 wt % and less than 65 wt % of UV-absorbing additives.

25. A method according to claim 1, wherein said formulation includes 40 to 80 wt % vehicle and 20 to 60 wt % UV-absorbing additives.

26. A method according to claim 1, wherein said liquid formulation has a viscosity of less than 50000 cp at 25° C.

27. A method according to claim 1, wherein said first polymeric material is selected from polycarbonate, polyesters, acrylics, halogenated polymers, polyolefins, aromatic homopolymers and copolymers derived from vinyl aromatic monomers and graft copolymers thereof.

28. A method according to claim 1, wherein said first polymeric material comprises polycarbonate.

29. A method according to claim 1, wherein said first layer has a thickness in the range 5 μm to 100 μm.

30. A method according to claim 1, wherein said second layer comprises a second polymeric material selected from polycarbonate, polyesters, acrylics, halogenated polymers such as polyvinylchloride (PVC), polyolefins, aromatic homopolymers and copolymers derived from vinyl aromatic monomers and graft copolymers thereof.

31. A method according to claim 1, wherein said second layer comprises a polycarbonate.

32. A method according to claim 1, wherein said first layer includes 0.1 to 20 wt % of said UV-absorbing additives.

33. A liquid formulation for making a structure comprising a vehicle and an additive as described in claim 8.

34. A structure which comprises:
(a) a first layer which comprises a first polymeric material and a UV-absorbing compound; and
(b) a second layer,
wherein said first layer includes one or more of the following:
(a) free vehicle of the type described in claim 8;
(b) a residue derived from vehicle of the type described in claim 8.

35. An assembly comprising:
(a) a first extruder for extruding first polymeric material;
(b) a receptacle containing a liquid formulation as described in claim 1;
(c) injection means operatively connected to the receptacle for injecting liquid formulation extracted from the receptacle into the polymeric material in or downstream of the first extruder;
(d) mixing means for mixing liquid formulation and first polymeric material.
